(19) United States
(12) Patent Application Publication
(10) Pub. No.: US 2026/0352044 A1
(43) Pub. Date: Nov. 5, 2026

(54) FIBER REINFORCED COMPOSITE ARMATURE WINDING SUPPORT STRUCTURE FOR A SUPERCONDUCTING MACHINE

(71) Applicant: General Electric Renovables España, S.L., Barcelona (ES)

(72) Inventors: James Michael Fogarty, Schenectady, NY (US); Curtis Maurice Hebert, Guilderland, NY (US)

(21) Appl. No.: 18/997,327

(22) PCT Filed: Jul. 22, 2022
(86) PCT No.: PCT/US2022/038027

§ 371 Date: Jan. 21, 2025

(51) Int. Cl. H02K 1/26; H02K 3/24; H02K 7/18; H02K 55/00

(52) U.S. Cl. CPC H02K 1/265; H02K 3/24; H02K 7/183; H02K 55/00

(57) ABSTRACT

A rotary machine includes a field winding assembly and an armature winding assembly having a plurality of winding modules. Each of the plurality of winding modules includes a plurality of conducting coils and at least one armature winding support structure. The armature winding support structure includes a body and a plurality of slots defined between adjacent teeth that extend radially from the body. The plurality of slots receive and support a subset of the plurality of conducting coils therein. The armature winding support structure further includes a plurality of support bars arranged within the body and a fiber-reinforced composite structure secured around each of the plurality of winding modules.

### RELATED APPLICATION

The present application claims priority to PCT Application No. PCT/US2022/038027, filed Jul. 22, 2022, which is incorporated herein by reference in its entirety.

### STATEMENT REGARDING FEDERALLY SPONSORED RESEARCH OR DEVELOPMENT

This invention was made with U.S. government support under DE-EE0008787 awarded by the U.S. Department of Energy. The U.S. government may have certain rights in the invention.

### FIELD

The present disclosure relates in general to superconducting machines, and more particularly to armature winding support structures for superconducting machines.

### BACKGROUND

Wind turbines have received increased attention as an environmentally safe and relatively inexpensive alternative energy source. With this growing interest, considerable efforts have been made to develop wind turbines that are reliable and efficient. Generally, a wind turbine includes a plurality of rotor blades coupled via the rotor hub to the main shaft of the turbine. The rotor hub is positioned on top of a tubular tower or base. Utility grade wind turbines (i.e., wind turbines designed to provide electrical power to a utility grid) can have large rotors (e.g., 100 or more meters in diameter). The rotor blades convert wind energy into a rotational torque or force that drives the generator, rotationally coupled to the rotor.

Low reactance machines (e.g., superconducting generators) are being explored for use in wind turbine installations, particularly in offshore installations. In such machines, the low reactance is a natural result of an air gap winding (discussed below), which gives rise to higher forces and torques in the armature winding during abnormal events, such as an electrical fault on the winding or equipment connected to the winding. Those higher forces and torques must be managed so that destructive motions of the winding conductors do not occur. These machines use superconducting field windings and assemblies of armature coils, cooling systems, and nonmagnetic teeth disposed between coils in the armature. In a particular design, the superconducting generator includes an armature winding assembly that, unlike conventional machine (e.g., conventional, non-superconducting generator) configurations, rotates within a superconducting field assembly, which includes a cryostat with superconducting field coils inside the cryostat.

Moreover, the armature windings in rotating electric machinery, such as motors and generators, typically imbed the conductors that include the armature winding in an iron structure (such as a magnetic core) that contains axial slots to receive the conductors. The iron structure is configured to enhance the performance of the electric machine and provide mechanical support to the winding. In an electric machine that employs superconducting coils in the field winding, the magnetic fields in the air gap between the superconducting coils and the armature winding may be sufficiently strong to magnetically saturate the teeth of that magnetic core. It is common in those cases to remove the portions of the magnetic core that are closest to the field coils leaving just an annular ring. The armature winding, lacking any magnetic materials, can then be attached to that annular ring in the space between the ring and the field coils. The winding, in this instance, may be referred to as an air gap winding.

In certain instances, an air gap winding can be associated with certain issues. For example, the magnetic forces that produce the braking torque on the rotor normally act on the iron teeth that contain the armature winding. However, in the air gap winding, these magnetic forces act on the conductors themselves. In addition, the absence of the teeth means that the support of the coils must be accomplished by other means. An underlying principle to designing and manufacturing a reliable armature winding is to minimize or eliminate space in the assembly such that vibration or movement (other than thermal expansion) cannot occur. If space is available, a conductor will eventually move into that space. Moreover, movement leads to wear, creation of more space, and failure.

In particular, there multiple sources of movement in an armature winding that can lead to a failure of the winding, which include, thermal expansion, normal vibration, and fault forces. Thermal expansion forces are imposed each time the generator changes the power it is producing. Higher power output corresponds to greater current in the winding, greater losses, and higher temperatures. That increase in temperature causes the winding to expand, most significantly in the axial direction. The thermal forces that drive that expansion are unavoidable but can be accurately calculated and they are imposed on the winding over a period of seconds to minutes. Normal vibration of the winding results from magnetic forces acting directly on the conductors that will be an order of magnitude less than the thermal forces but occur at twice the electrical frequency. Fault forces occur very infrequently and unexpectedly. However, when fault forces occur, their magnitude may be 100 times that of the thermal forces and may be high enough to fracture the insulation on the armature conductors or to dislodge those conductors from their normal positions.

In view of the aforementioned, the art is continuously seeking new and improved generators, and more particularly, armature winding support structures for superconducting generators.

### BRIEF DESCRIPTION

Aspects and advantages of the invention will be set forth in part in the following description, or may be obvious from the description, or may be learned through practice of the invention.

In an aspect, the present disclosure is directed to a rotary machine. The rotary machine includes a field winding assembly and an armature winding assembly having a plurality of winding modules. Each of the plurality of winding modules includes a plurality of conducting coils and at least one armature winding support structure. The armature winding support structure includes a body and a plurality of slots defined between adjacent teeth that extend radially from the body. The plurality of slots receive and support a subset of the plurality of conducting coils therein. The armature winding support structure further includes a plurality of support bars arranged within the body and a fiber-reinforced composite structure secured around each of the plurality of winding modules.

In another aspect, the present disclosure is directed to an armature winding assembly. The armature winding assembly includes a plurality of winding modules. Each of the plurality of winding modules includes a plurality of conducting coils and at least one armature winding support structure. The armature winding support structure includes a body and a plurality of slots defined between adjacent teeth that extend radially from the body. The plurality of slots receive and support a subset of the plurality of conducting coils therein. The armature winding support structure further includes a plurality of support bars arranged within the body and a fiber-reinforced composite structure secured around each of the plurality of winding modules.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine having a generator according to the present disclosure;

FIG. 2 illustrates a perspective, internal view of one embodiment of a nacelle of a wind turbine having a superconducting generator according to the present disclosure;

FIG. 3 illustrates a side view of a generator in accordance with aspects of the present invention;

FIG. 4 illustrates a front view of an embodiment of an armature winding assembly of a generator according to the present disclosure;

FIG. 5 illustrates a front view of an embodiment of a winding module of an armature winding support structure for an armature winding assembly of a generator according to the present disclosure;

FIG. 6 illustrates a front view of another embodiment of a winding module of an armature winding support structure for an armature winding assembly of a generator according to the present disclosure;

FIG. 7 illustrates a front view of an embodiment of a body of a winding module of an armature winding support structure according to the present disclosure;

FIG. 8 illustrates a front view of another embodiment of a body of an armature winding support structure according to the present disclosure;

FIG. 9 illustrates a side view of an embodiment of a winding module of an armature winding support structure for an armature winding assembly of a generator according to the present disclosure;

FIG. 10 illustrates a front view of an embodiment of a winding module of an armature winding support structure for an armature winding assembly of a generator according to the present disclosure, particularly illustrating radial and tangential forces acting on the winding module;

FIG. 11 illustrates a front view of another embodiment of a winding module of an armature winding support structure for an armature winding assembly of a generator according to the present disclosure, particularly illustrating radial and tangential forces acting on the winding module; and

FIG. 12 illustrates a simplified view of an embodiment of the transmission of radial forces to a rotating component of the generator through various components of an armature winding support structure according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Generally, the present disclosure is directed to rotary machines having a field winding assembly and an armature winding assembly having a plurality of winding modules. Each of the plurality of winding modules includes a plurality of conducting coils and a plurality of armature winding support structures. Each of the armature winding support structures a body, a plurality of slots defined between adjacent teeth that extend radially from the body, a plurality of support bars arranged within the body, and a fiber-reinforced composite structure secured around each of the plurality of winding modules. The plurality of slots receive and support a subset of the plurality of conducting coils therein.

Thus, in an embodiment, the armature winding assembly is arranged to produce, for example, alternating north and south magnetic poles on the surface of the rotatable component. In an embodiment, each pair of north/south poles, referred to herein as a winding module, may include a magnetic iron core typically fabricated from thin iron laminations and held in compression by several axial compression studs. In addition, the winding module includes a set of conducting coils connected in a manner to produce the north and south magnetic effects, electrical insulation around those conducting coils, cooling passages, and/or filler materials. Moreover, in an embodiment, the winding module may include coil wedge teeth, a non-metallic coil cover structure that projects inward between the coils for the full extent of the active length of the winding, and fiber-reinforced composite bands to contain the module components.

Accordingly, the present disclosure provides many advantages not present in the prior art. For example, with the proper construction of the conducting coils, the axial wedge blocks, cooling channels, and/or full length radial teeth, it is possible to eliminate any space within the winding module that would allow motion of the conducting coils. In addition, given that some embodiments of the present disclosure may be quite large compared to conventional generators of similar electrical rating, one must expect minor deflections of the large structure, or accumulations of minor variations in sizes of assemblies that might lead to excessive clearance within the winding. As an example, the slower the generator rotates, the larger the generator must be for the same power and torque. High speed (e.g., 3600 rpm) generators typically have rotor diameters of about 0.3 meters to about 1.2 meters, as an example. Anything larger will have excessive mechanical stresses. Thus, wind turbines having lower speeds (such as 8 rpm or so) have generator rotor diameters on the order of 5-10 meters, an order of magnitude greater than conventional generators. However, the banding of the present disclosure being placed around just two poles of the winding assembly more effectively limits the clearances that might otherwise accumulate. Thus, in an embodiment, the banding placed around portions of the winding module can ensure that that tight packing remains in place, thereby leading to effective and reliable support of the armature coils. In addition, the use of the fiber-reinforced composite bands is cost effective and the process of manufacturing the winding modules can be automated to achieve uniform application of the fiber-reinforced composite bands to ensure a reliable product.

In further embodiments, the individual winding modules may be removable for service and/or replacement from the rotating component while the generator is assembled atop the wind turbine. In particular, in an embodiment, the present disclosure is directed to a winding module in which the entire contents of the module (e.g., the iron laminations, conducting coils, cooling channels, non-metallic supports, etc.) are all completely contained within that module. Such containment facilitates the removal of the winding module from the rotating component for ease of service and/or replacement.

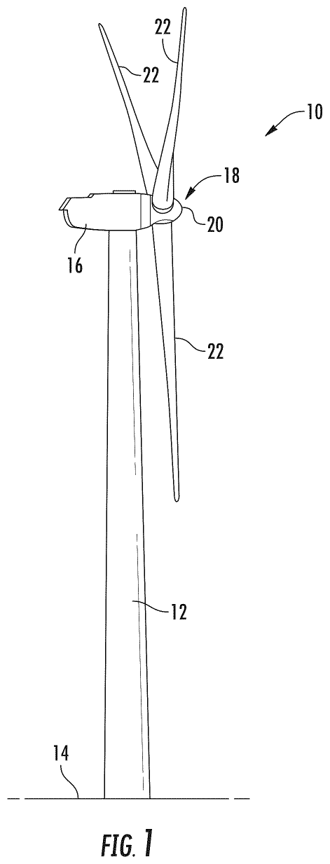

Referring to the drawings, FIG. 1 illustrates a perspective view of a wind turbine 10. As mentioned, the present disclosure is directed to a generator that, although not limited to such use, is particularly well-suited for use in a wind turbine 10. Although FIG. 1 depicts an “on-shore” (land-based) wind turbine 10 installation, it should be appreciated that the present invention is not limited to onshore wind turbines and is just as applicable to “off-shore” (water-based) wind turbine installations.

Although a superconducting generator is depicted in the figures and described herein, it should be understood that the invention is not limited to a superconducting generator and is applicable to any generator configuration having a rotating component. For example, a generator may be configured so that the armature winding assembly rotates around a stationary field assembly. In an alternate generator configuration, the field assembly may rotate around a stationary armature winding assembly. In yet another alternate generator configuration, the generator may include a rotating permanent magnet field with less expensive permanent magnet materials.

Referring still to FIG. 1, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or fewer than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

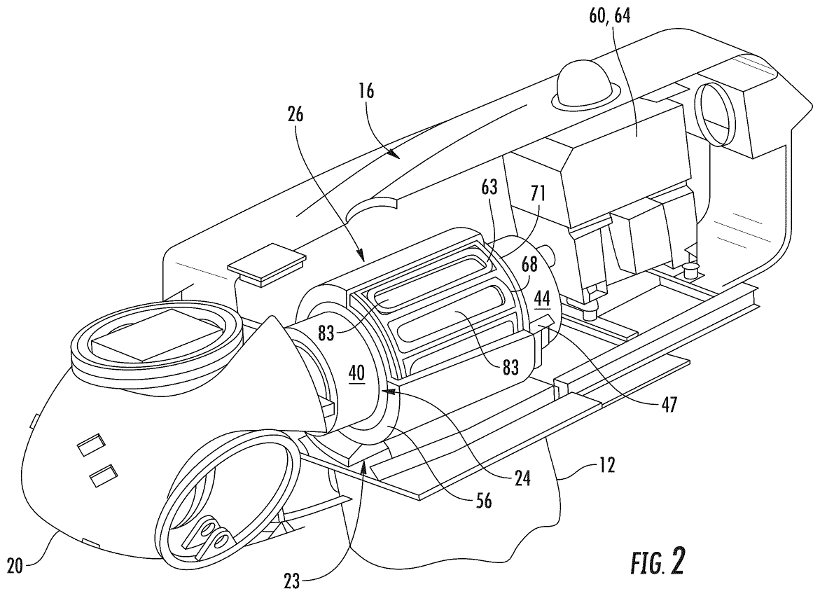

Referring now to FIG. 2, a perspective, internal view of an embodiment of the nacelle 16 having a superconducting generator 23 housed therein according to the present disclosure is illustrated. Further, as shown, a support tube 40 is connected directly to the hub 20 and supports an armature winding assembly 24. Thus, the armature winding assembly 24 is considered as the rotating component of the generator 23 with a rotating first electromagnetic component configuration in the form of conducting coils 27 (with end turns 28) that rotate around a stationary field assembly 26 having a second electromagnetic component configuration, such as a superconducting field winding assembly 26.

The stationary field assembly 26 includes superconducting coils 63, which may be a group of wires formed in a racetrack shape. As used herein, a “racetrack” shape generally refers to a two-dimensional shape constructed of a rectangle or square with semicircles at a pair of opposite ends. Thus, in certain embodiments, the superconducting coils 63 are constrained to retain the racetrack shape. Moreover, as shown, each superconducting coil 63 is supported in a recess/passage 83 in a casing 71 that may be cooled by a bath of helium to cryogenic temperatures or by some other method known with the engineering field of cryogenics. As such, the casing 71 may be supported in a cryostat housing 56 which is fixed to a base tube 44. Thus, as shown in the illustrated embodiment, a mount 47 may support the base tube 44 within the nacelle 16.

Still referring to FIG. 2, the superconducting coils 63 may be arranged side by side in an annular array extending around the casing 71. For example, in an embodiment, thirty-six (36) coils may form an annular array of field windings that serve as the stator field winding for the generator 23. Furthermore, in an embodiment, the superconducting coils 63 may be each formed of (NbTi or other superconducting) wire wrapped in a helix around a racetrack form that may include cooling conduits for the helium.

In additional embodiments, cryogen re-condensers 60, 64 may be housed in the nacelle 16, provided that the cryogen cooling liquid in the re-condensers 60, 64 is at least partially elevated above the superconducting field windings to provide for gravity feed of the cryogen to the windings. Alternatively, the re-condensers 60, 64 may be mounted on top of the nacelle 16.

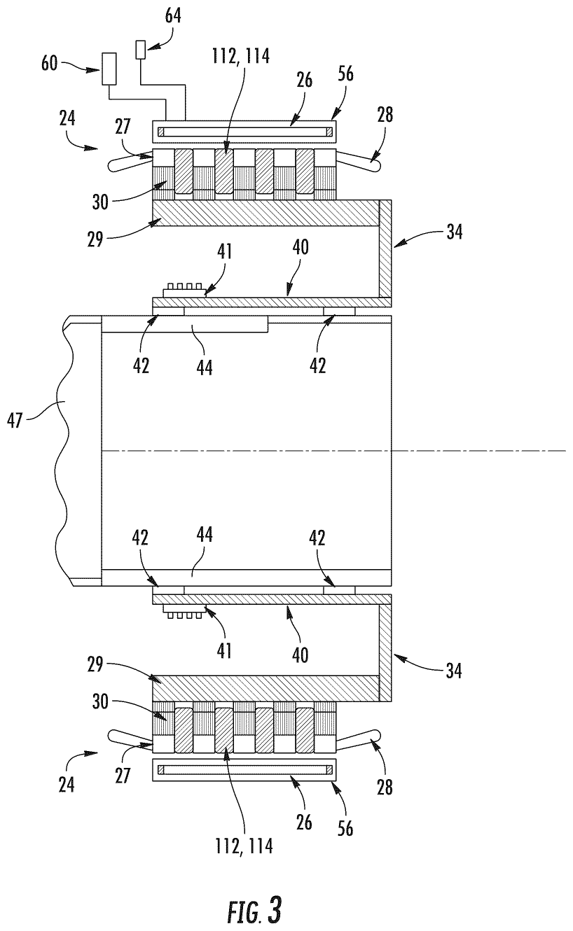

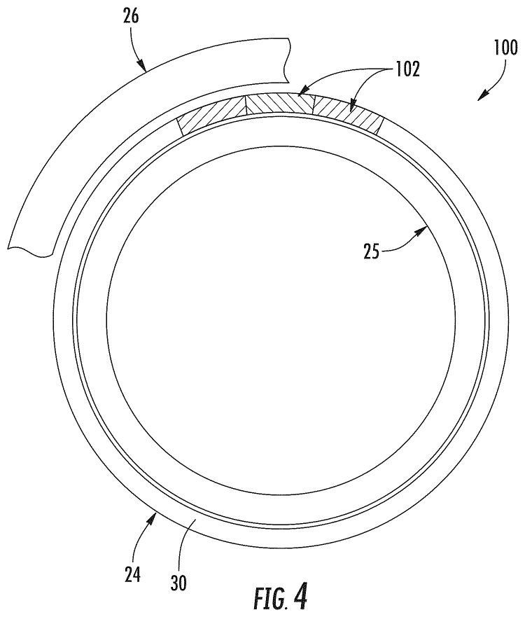

Referring now to FIG. 3, a cross-section of an embodiment of the superconducting generator 23 with the annular rotating armature winding assembly 24 (“armature 24”) radially inward of the stationary field assembly 26 is illustrated. In particular, as shown, the armature 24 is essentially an inner annular ring configuration (FIG. 4) that rotates within the stationary field assembly 26. The armature 24 includes the conducting coils 27, e.g., coils or bars, arranged longitudinally along the length of the armature 24 and on an inside cylindrical surface of the armature 24. The conducting coils 27 may be connected at their opposite ends to one another by conductive end turns 28. The end turn connections 28 between the longitudinal conducting coils 27 are dependent on their number and arrangement, and the phases of electricity to be generated in the conducting coils 27. The inside cylindrical surface of the armature windings is separated by a narrow air gap, e.g., about 10-25 mm, from the outer surface of the stationary field assembly 26.

Thus, in an embodiment, the armature 24 may be configured to rotate with a generator rotor 25 (FIG. 4) with a rotating electromagnetic component configuration (e.g., conducting coils 27 and end turns 28) while the stationary field assembly 26 may constitute a stationary component with a stationary electromagnetic component configuration (superconducting coils 63 (FIG. 2)).

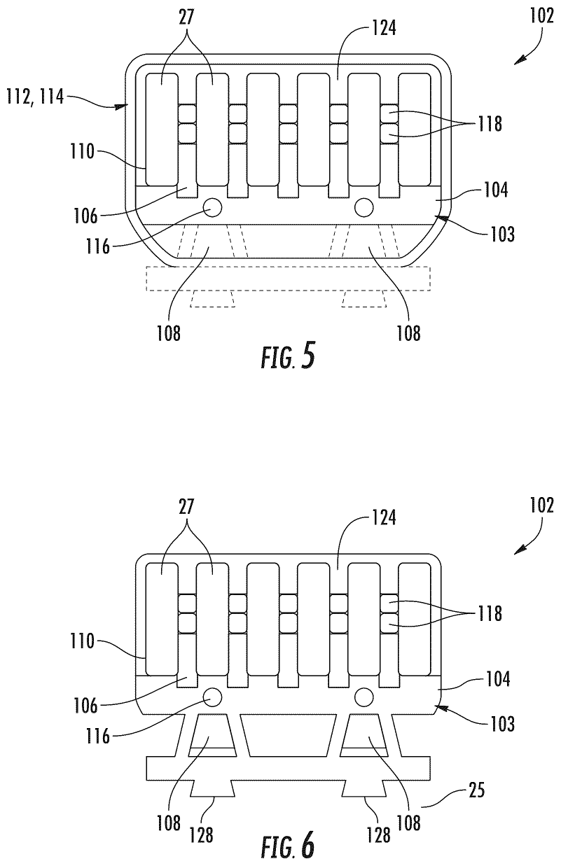

Referring generally to FIGS. 3-8, the armature 24 includes a cylindrical yoke or body 30 (referred to as “body” herein) that supports the conducting coils 27. In particular, the conducting coils 27 are contained in slots 110 (FIGS. 5-6) defined between adjacent teeth 106 that extend radially from the body 30. The body 30 and teeth 106 may be a layered, laminated construction. For example, in an embodiment, the layered construction of the body 30 may include sheets of magnetic steel (e.g., about 0.5 mm thick) for commonly recognized electromagnetic purposes. Further, in an embodiment, the teeth 106 may include layers of glass fibers molded to form that shape or other suitable constructions of nonmetallic materials. The inner surface of the body 30 is fixed to a cylindrical housing 29 that rotates with the armature 24. The housing 29 is fitted to a circular disc 34 that supports the housing 29 and armature 24.

The circular disc 34 is secured to a rotating cylindrical support tube 40. On an outside surface of the support tube 40, a slip ring assembly 41 is provided with contacts for each of the phases of AC power produced by the generator 23. The slip ring 41 is electrically coupled to the conducting coils 27 of the rotating armature 24 and rotates with the support tube 40. A stationary connection, e.g., carbon brushes (not shown), conducts the electricity from the slip ring 41 and armature 24 to wire conductors that extend to an electronic power converter and a step-up transformer before going down the tower and are coupled to a power utility grid, factory or other electrical power load.

A pair of annular bearings 42 are arranged towards opposite ends of the support tube 40 and rotatably support the support tube 40 on the stationary base tube 44 that is attached to the mount 47, which is supported by the floor of the nacelle 16.

The cryostat housing 56 insulates the superconducting coils so that they may be cooled to near absolute zero, e.g., to 10 Kelvin (K) and preferably to 4K. To cool the windings, the cryostat housing 56 may include one or more insulated conduits 58 to receive liquid helium (He) or other similar cryogenic liquid (referred to as cryogen). A conventional two-stage re-condenser 60 is mounted in an upper region of the nacelle 16, on top of the nacelle 16, or on top of the tower 12, and above the field windings to provide cryogen, e.g., liquid He, using a gravity feed. The second re-condenser 64 provides a second cooling liquid, e.g., liquid nitrogen or neon, to an inner thermal shield of the cryostat housing 56 via conduit 66.

Referring now to FIGS. 4-12, various components of embodiments of a fiber-reinforced composite armature winding support 100 for the armature winding assembly 24 according to aspects of the present disclosure are illustrated. In particular, as shown in FIG. 4, a front view of an embodiment of the armature winding assembly 24 of the generator 23 according to the present disclosure is illustrated. More specifically, as shown, the generator 23 includes a non-rotatable component supporting a field winding assembly, such as the stationary field assembly 26, and a rotatable component, such as the generator rotor 25 with the armature winding assembly 24 mounted thereto, oriented to rotate relative to the stationary field assembly 26 during operation of the generator 23. Thus, in certain embodiments, for example, the armature winding assembly 24 is fixedly coupled to the generator rotor 25 so as to rotate therewith during the operation of the generator 23.

As mentioned, the armature winding assembly 24 includes a plurality of conducting coils 27. More specifically, as shown in FIGS. 4-6, the armature winding assembly 24 has a plurality of winding modules 102. Each of the plurality of winding modules 102 includes a plurality of conducting coils 27 and at least one armature winding support structure 103. More specifically, as shown in FIG. 4, the plurality of winding modules 102 are arranged circumferentially around the rotatable component (i.e., the generator rotor 25). In certain embodiments, for example, each of the plurality of winding modules 102 may extend from about 10 degrees to about 20 degrees of a circumference of the armature winding assembly 24, such as about 18 degrees.

Referring particularly to FIGS. 5 and 6, two axial cross-sections of one of the winding modules 102 are illustrated. For clarity, FIGS. 5 and 6 illustrate a winding module 102 having six conducting coils 27, however, it should be understood that the winding modules 102 described herein may include any suitable number of conducting coils 27, such as 24 or more. Moreover, FIG. 5 illustrates a cross-section where the module components are contained by the fiber-reinforced composite bands 114 as described herein without being attached to the generator rotor 25, whereas FIG. 6 illustrates a different cross-section at a point where the winding module 102 is secured to the generator rotor 25, e.g., via dovetail connections 128.

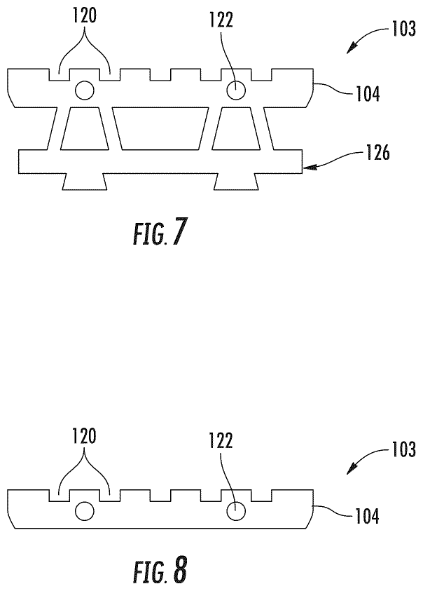

As shown generally in FIGS. 5-8, the armature winding support structure 103 includes a body 104 that may be constructed of one or more iron laminations. Furthermore, FIG. 5 illustrates a front view of an embodiment of a winding module 102 having a body 104 with a first iron lamination configuration, whereas FIG. 6 illustrates a front view of another embodiment of a winding module 102 having body 104 with a different, second iron lamination. In particular, the body 104 illustrated in FIG. 7 has a supporting structure 126 disposed radially between the body 104 and the generator rotor 25, whereas FIG. 8 lacks the supporting structure 126 and is used in regions that are wrapped by the fiber-reinforced composite bands 114 described herein.

Further, as shown, the armature winding support structure 103 includes a plurality of slots 110 defined between adjacent teeth 106 that extend radially from the body 104. For example, as shown, the adjacent teeth 106 may include a plurality of wedge teeth arranged within a plurality of recesses 120 (FIGS. 7-8) formed into the body 104 so as to provide lateral (tangential) support to the conducting coils 27. In such embodiments, as shown, the plurality of slots 110 receive and support a subset of the plurality of conducting coils 27 therein.

Moreover, in an embodiment, as shown in FIGS. 5-6 and 9-10, each winding module 102 may include a coil cover structure 124 extending around the plurality of conducting coils 27 inside of the fiber-reinforced composite structure 112. As such, in an embodiment, the conducting coils 27 may be placed on an outer surface of the body 104 between the teeth 106. In another embodiment, the coil cover structure 124 may include a plurality of full length non-metallic coil caps that may be inserted over and between the radially outer portions of the conducting coils 27. Accordingly, in an embodiment, the coil cover structure 124 may be molded or machined from a suitable material with a peripheral span of two or more conducting coils 27. Thus, the coil caps can be distinguished from the wedge teeth 106, which occupy only a single space between the conducting coils 27.

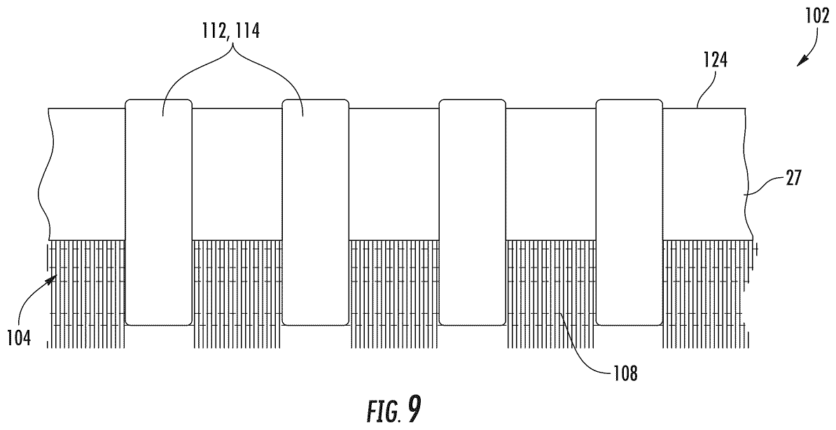

Further, as shown in FIGS. 5, 9, and 10, each winding module 102 includes a fiber-reinforced composite structure 112 secured around each of the plurality of winding modules 102. For example, in an embodiment, as shown, the fiber-reinforced composite structure 112 may include one or more fiber-reinforced composite bands 114, such as a plurality of fiber-reinforced composite bands 114, as shown in FIG. 9. Thus, as shown in FIG. 9, the fiber-reinforced composite bands 114 may be wrapped around the individual bodies 104 and the subset of the plurality of conducting coils 27 and cured thereon to form one of the winding modules 102. In particular, FIG. 9 illustrates a side view of one of the winding modules 102 in which several banded portions are interspersed with portions for attachments to the generator rotor 25. As such, the fraction of the length supported by the fiber-reinforced composite bands 114 and the fraction attached to the generator 25 can be determined such that all mechanical forces are properly considered.

In particular embodiments, the fiber-reinforced composite bands 114 may be constructed of, for example, glass fibers or carbon fibers. In such embodiments, the fiber-reinforced composite bands 114 do not prevent axial expansion from thermal forces. Rather, the fiber-reinforced composite bands 114 can act without restraint and restrain the conducting coils 27 against radial and tangential motion. As such, in an embodiment, the forces driving that motion will be the load torque, the normal operational vibration, and/or the fault forces.

In additional embodiments, as shown, each winding module 102 includes a plurality of support bars 108 arranged within the body 104. In such embodiments, the support bars 108 may be constructed of, for example, a metal or metal alloy. Accordingly, in an embodiment, the support bars 108 may include a set of full-length axial members (“key bars”) on the radially inner portion of the winding module 102 so as to axially transfer the forces acting on the banded portions of the module 102 to those portions attached to the generator rotor 25.

In further embodiments, as shown in FIGS. 5-6 and 9-10, the armature winding support structure 103 may also include one or more axially-extending studs 116 for providing compression to a respective winding module 102. Thus, as shown in FIGS. 7 and 8, the body 104 of the armature winding support structure 103 may include one or more through holes 122 for receiving the axially-extending stud(s) 116.

Moreover, in an embodiment, as shown in FIGS. 5-6 and 9-10, each of the winding modules 102 may further include one or more cooling channels 118 arranged between each of the conducting coils 27. In such embodiments, the cooling channel(s) are configured to remove heat from the conducting coils 27.

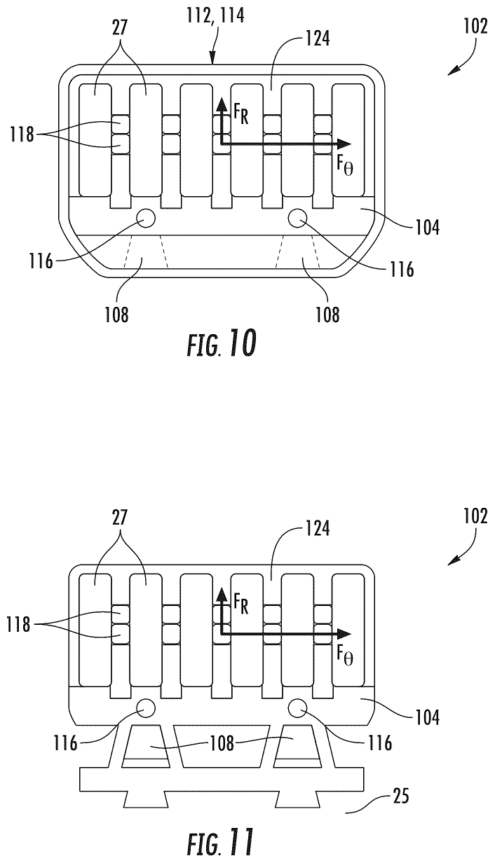

Referring particularly to FIGS. 10 and 11, a tangential force, Fe, and a radial force, FR, are illustrated being imposed on the winding modules 102 of FIGS. 5 and 6, respectively. Such forces are largely uniform over the axial active length of the winding module 102, such that the forces are imposed on the banded sections and also the un-banded sections. Thus, in an embodiment, the wedge teeth 106 and the non-metallic coil cover structure 124 are configured to transfer the forces from the un-banded sections to the adjacent banded sections.

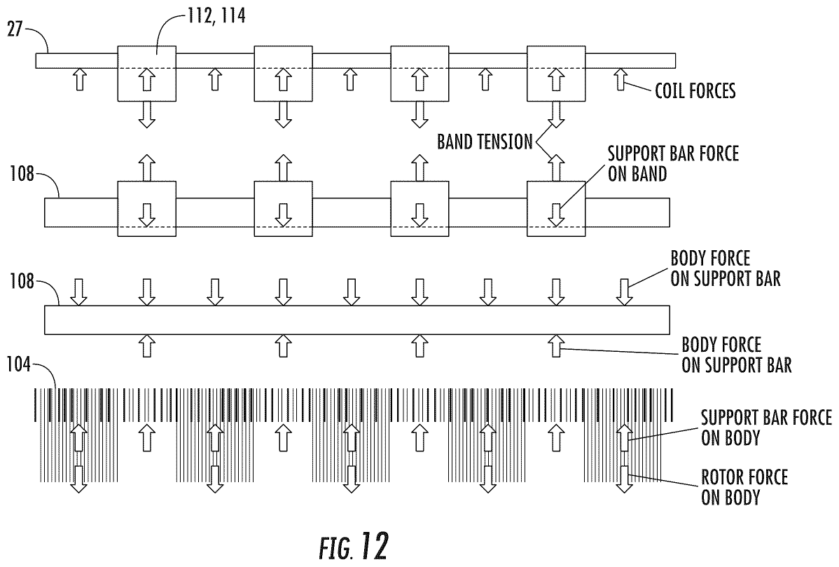

Moreover, and referring to FIG. 12, a set of example free body diagrams showing how the radial forces on the winding modules 102 described herein are ultimately transmitted to the generator rotor 25. In particular, as shown, the various arrows illustrate the radial forces between the conducting coils 27, the support bars 108, and the body 104 of one of the winding modules 102.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Further aspects of the invention are provided by the subject matter of the following clauses:
Clause 1. A rotary machine, comprising:
a field winding assembly;
an armature winding assembly comprising a plurality of winding modules, each of the plurality of winding modules comprising a plurality of conducting coils and at least one armature winding support structure, the at least one armature winding support structure comprising:
   a body;
   a plurality of slots defined between adjacent teeth that extend radially from the body, the plurality of slots receiving and supporting a subset of the plurality of conducting coils therein;
   a plurality of support bars arranged within the body; and
   a fiber-reinforced composite structure secured around each of the plurality of winding modules.
Clause 2. The rotary machine of clause 1, wherein the body is constructed of one or more magnetic laminations.
Clause 3. The rotary machine of any of the preceding clauses, wherein the plurality of support bars are constructed of a metal or metal alloy, one or more of the plurality of support bars extending a full axial length of one of the plurality of winding modules so as to axially transfer forces acting on the fiber-reinforced composite structure to a rotatable component of the rotary machine.
Clause 4. The rotary machine of any of the preceding clauses, wherein the fiber-reinforced composite structure comprises one or more fiber-reinforced composite bands.
Clause 5. The rotary machine of clause 4, wherein the one or more fiber-reinforced composite bands are constructed of at least one of glass fibers, synthetic fibers, polymer fibers, wood fibers, ceramic fibers, metal fibers, carbon fibers, or combinations thereof.
Clause 6. The rotary machine of any of the preceding clauses, wherein the fiber-reinforced composite structure is wrapped around the body and the subset of the plurality of conducting coils and cured thereon to form one of the plurality of winding modules.
Clause 7. The rotary machine of any of the preceding clauses, wherein each of the plurality of winding modules further comprises one or more axially-extending studs for providing compression to a respective winding module.
Clause 8. The rotary machine of any of the preceding clauses, wherein each of the plurality of winding modules further comprises one or more cooling channels arranged adjacent to or within the plurality of conducting coils.
Clause 9. The rotary machine of any of the preceding clauses, wherein the adjacent teeth comprise a plurality of wedge teeth arranged within a plurality of recesses formed into the body.
Clause 10. The rotary machine of clause 9, further comprising a coil cover structure extending around the plurality of conducting coils inside of the fiber-reinforced composite structure.
Clause 11. The rotary machine of any of the preceding clauses, wherein each of the plurality of winding modules extends from about 10 degrees to about 20 degrees of a circumference of the armature winding assembly.
Clause 12. The rotary machine of any of the preceding clauses, wherein at least one of the field winding assembly and the armature winding assembly is a superconducting winding assembly having superconducting coils.
Clause 13. An armature winding assembly, comprising:
a plurality of winding modules, each of the plurality of winding modules comprising a plurality of conducting coils and at least one armature winding support structure, the at least one armature winding support structure comprising:
a body;
a plurality of slots defined between adjacent teeth that extend radially from the body, the plurality of slots receiving and supporting a subset of the plurality of conducting coils therein;
a plurality of support bars arranged within the body; and
a fiber-reinforced composite structure secured around each of the plurality of winding modules.
Clause 14. The armature winding assembly of clause 13, wherein the body is constructed of one or more magnetic laminations.
Clause 15. The armature winding assembly of clauses 13-14, wherein the plurality of support bars are constructed of a metal or metal alloy, one or more of the plurality of support bars extending a full axial length of one of the plurality of winding modules so as to axially transfer forces acting on the fiber-reinforced composite structure to a rotatable component of the rotary machine.
Clause 16. The armature winding assembly of clauses 13-15, wherein the fiber-reinforced composite structure comprises one or more fiber-reinforced composite bands, wherein the one or more fiber-reinforced composite bands are constructed of at least one of glass fibers, synthetic fibers, polymer fibers, wood fibers, ceramic fibers, metal fibers, carbon fibers, or combinations thereof.
Clause 17. The armature winding assembly of clauses 13-16, wherein the fiber-reinforced composite structure is wrapped around the body and the subset of the plurality of coils and cured thereon to form one of the plurality of winding modules. Clause 18. The armature winding assembly of clauses 13-17, wherein each of the plurality of winding modules further comprises one or more axially-extending studs for providing compression to a respective winding module.
Clause 19. The armature winding assembly of clauses 13-18, wherein the adjacent teeth comprise a plurality of wedge teeth arranged within a plurality of recesses formed into the body, and wherein the armature winding support structure further comprises a coil cover structure extending around the plurality of coils inside of the fiber-reinforced composite structure.
Clause 20. The armature winding assembly of clauses 13-19, wherein each of the plurality of winding modules extends from about 10 degrees to about 20 degrees of a circumference of the armature winding assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotary machine, comprising:
a field winding assembly;
an armature winding assembly comprising a plurality of winding modules, each of the plurality of winding modules comprising a plurality of conducting coils and at least one armature winding support structure, the at least one armature winding support structure comprising:
a body;
a plurality of slots defined between adjacent teeth that extend radially from the body, the plurality of slots receiving and supporting a subset of the plurality of conducting coils therein;
a plurality of support bars arranged within the body; and
a fiber-reinforced composite structure secured around each of the plurality of winding modules.

2. The rotary machine of claim 1, wherein the body is constructed of one or more magnetic laminations.

3. The rotary machine of claim 1, wherein the plurality of support bars are constructed of a metal or metal alloy, one or more of the plurality of support bars extending a full axial length of one of the plurality of winding modules so as to axially transfer forces acting on the fiber-reinforced composite structure to a rotatable component of the rotary machine.

4. The rotary machine of claim 1, wherein the fiber-reinforced composite structure comprises one or more fiber-reinforced composite bands.

5. The rotary machine of claim 4, wherein the one or more fiber-reinforced composite bands are constructed of at least one of glass fibers, synthetic fibers, polymer fibers, wood fibers, ceramic fibers, metal fibers, carbon fibers, or combinations thereof.

6. The rotary machine of claim 1, wherein the fiber-reinforced composite structure is wrapped around the body and the subset of the plurality of conducting coils and cured thereon to form one of the plurality of winding modules.

7. The rotary machine of claim 1, wherein each of the plurality of winding modules further comprises one or more axially-extending studs for providing compression to a respective winding module.

8. The rotary machine of claim 1, wherein each of the plurality of winding modules further comprises one or more cooling channels arranged adjacent to or within the plurality of conducting coils.

9. The rotary machine of claim 1, wherein the adjacent teeth comprise a plurality of wedge teeth arranged within a plurality of recesses formed into the body.

10. The rotary machine of claim 9, further comprising a coil cover structure extending around the plurality of conducting coils inside of the fiber-reinforced composite structure.

11. The rotary machine of claim 1, wherein each of the plurality of winding modules extends from about 10 degrees to about 20 degrees of a circumference of the armature winding assembly.

12. The rotary machine of claim 1, wherein at least one of the field winding assembly and the armature winding assembly is a superconducting winding assembly having superconducting coils.

13. An armature winding assembly, comprising:
a plurality of winding modules, each of the plurality of winding modules comprising a plurality of conducting coils and at least one armature winding support structure, the at least one armature winding support structure comprising:
a body;
a plurality of slots defined between adjacent teeth that extend radially from the body, the plurality of slots receiving and supporting a subset of the plurality of conducting coils therein;
a plurality of support bars arranged within the body; and
a fiber-reinforced composite structure secured around each of the plurality of winding modules.

14. The armature winding assembly of claim 13, wherein the body is constructed of one or more magnetic laminations.

15. The armature winding assembly of claim 13, wherein the plurality of support bars are constructed of a metal or metal alloy, one or more of the plurality of support bars extending a full axial length of one of the plurality of winding modules so as to axially transfer forces acting on the fiber-reinforced composite structure to a rotatable component of the rotary machine.

16. The armature winding assembly of claim 13, wherein the fiber-reinforced composite structure comprises one or more fiber-reinforced composite bands, wherein the one or more fiber-reinforced composite bands are constructed of at least one of glass fibers, synthetic fibers, polymer fibers, wood fibers, ceramic fibers, metal fibers, carbon fibers, or combinations thereof.

17. The armature winding assembly of claim 13, wherein the fiber-reinforced composite structure is wrapped around the body and the subset of the plurality of coils and cured thereon to form one of the plurality of winding modules.

18. The armature winding assembly of claim 13, wherein each of the plurality of winding modules further comprises one or more axially-extending studs for providing compression to a respective winding module.

19. The armature winding assembly of claim 13, wherein the adjacent teeth comprise a plurality of wedge teeth arranged within a plurality of recesses formed into the body, and wherein the armature winding support structure further comprises a coil cover structure extending around the plurality of coils inside of the fiber-reinforced composite structure.

20. The armature winding assembly of claim 13, wherein each of the plurality of winding modules extends from about 10 degrees to about 20 degrees of a circumference of the armature winding assembly.
